(19) United States
(12) Patent Application Publication
(10) Pub. No.: US 2013/0135310 A1
(43) Pub. Date: May 30, 2013

(54) Method and device for representing synthetic environments

(71) Applicant: Yannick JAMES, Cergy Pontoise (FR)

(72) Inventor: Yannick JAMES, Cergy Pontoise (FR)

(73) Assignee: THALES, Neuilly-sur-Seine (FR)

(21) Appl. No.: 13/323,101

(22) Filed: Dec. 12, 2011

(30) Foreign Application Priority Data
Nov. 24, 2011 (FR) FR1103579

(51) Int. Cl. G06T 15/20

(52) U.S. Cl. 345/427

(57) ABSTRACT

A method and a device for representing synthetic environments notably comprises a position detector of the observer, a synthesis image generator, and a conformal dynamic transformation module producing a rendering in two dimensions of a scene in three dimensions, said rendering being displayed by a calibrated display device. The invention can be implemented in the field of the simulation of mobile craft such as helicopters, airplanes, trucks.

The present invention relates to a method and a device for representing synthetic environments. The invention can be implemented in the field of the simulation of mobile craft such as helicopters, airplanes, trucks. Said simulation of mobile craft is notably intended for the training of the driver and of any copilots, as part of an initial or advanced training course.

In the field of virtual reality, or even of augmented reality, one aim of the synthetic environment representation software is to immerse the users in a visual scene which artificially recreates a real, symbolic or imaginary environment. The visual scene is constructed notably from data describing the geometry of the scene in space, the textures, the colors and other properties of the scene, stored in a database, called 3D (three-dimensional) database. The virtual scene is usually translated into video images in two dimensions by an image generator based on graphics processors. The video images in two dimensions obtained in this way are called “synthesis images”. The synthesis images can be observed by a user, or an observer, by means of one or more display screens.

In the field of simulation or virtual reality, a good visual immersion of the user is largely linked to the scale of the visual field reconstructed around the observer. The visual field is all the greater when there are a large number of screens. For example, a single standard screen generally allows an observer a small field of approximately sixty degrees horizontally by forty degrees vertically. A display system with a spherical or cubic screen, back projected by a number of projectors for example, makes it possible to observe all the possible visual field, or three hundred and sixty degrees in all directions. This type of display is produced in spheres of large dimensions or with infinity reflection mirrors, which are particularly costly.

The cost of a simulator also largely depends on its size and its bulk. The bulk of a simulator is directly linked to its environment representation device. In order to reduce the bulk of the simulator, one solution may be to bring the display of the observer closer. In the field of simulation, the display screens are situated at approximately two and a half to three meters from the observer. However, when the display screens are close to the observer, notably less than two meters away, significant geometrical aberrations appear in the synthesis image perceived by the observer. The geometrical aberrations are called parallax errors. The parallax errors are prejudicial to the quality of training.

In the field of simulation, video games, virtual reality, the parallax errors are corrected by a head position detector. However, this device does not work for static display systems.

One aim of the invention is notably to overcome the abovementioned drawbacks. To this end, the subject of the invention is a method and a device for representing environments as described in the claims.

The notable advantage of the invention is that it eliminates the parallax errors, regardless of the position of the observer relative to the screen and regardless of screen type.

Other features and advantages of the invention will become apparent from the following description, given as a nonlimiting illustration, and in light of the appended drawings which represent:

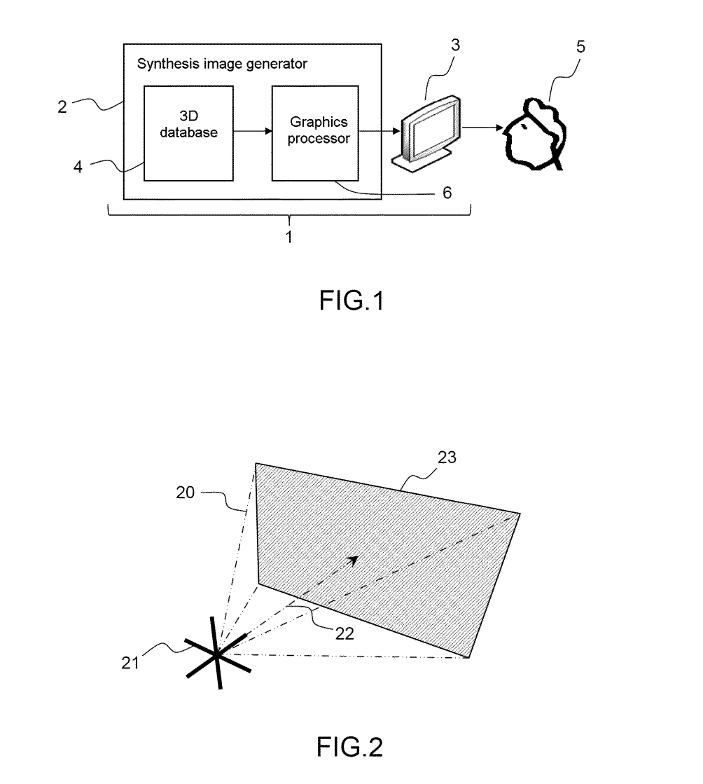

FIG. 1: a diagram of a display channel according to the prior art;

FIG. 2: a first vision pyramid according to the prior art;

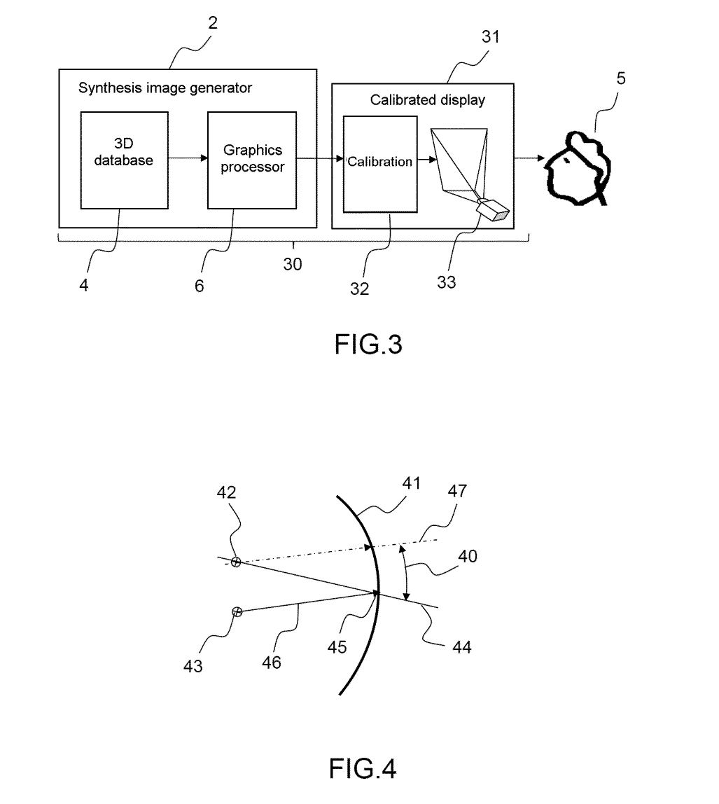

FIG. 3: a diagram of a synthesis image generator with calibrated screen according to the prior art;

FIG. 4: an example of parallax error;

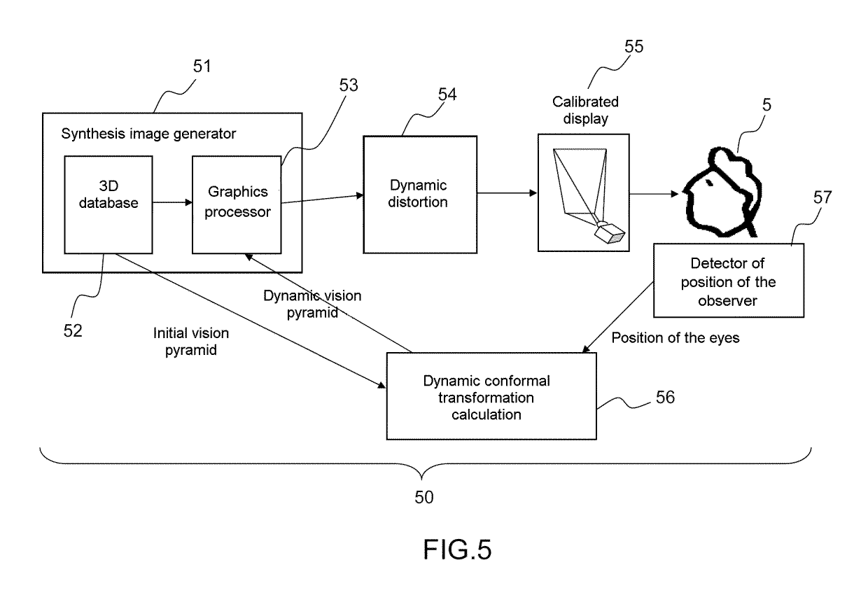

FIG. 5: a diagram of an image production system according to the invention;

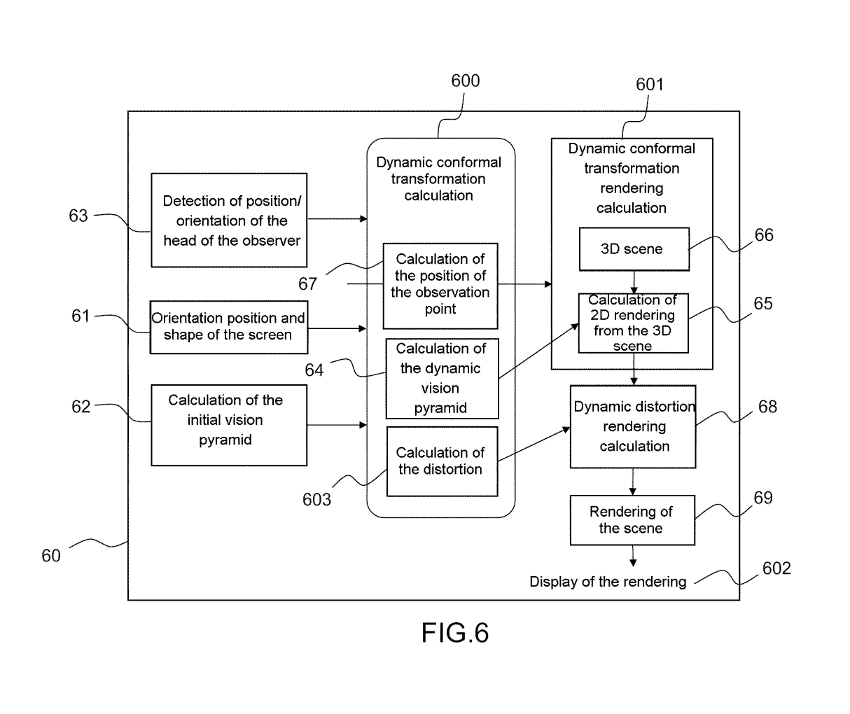

FIG. 6: the principal calculations of an image production system according to the invention;

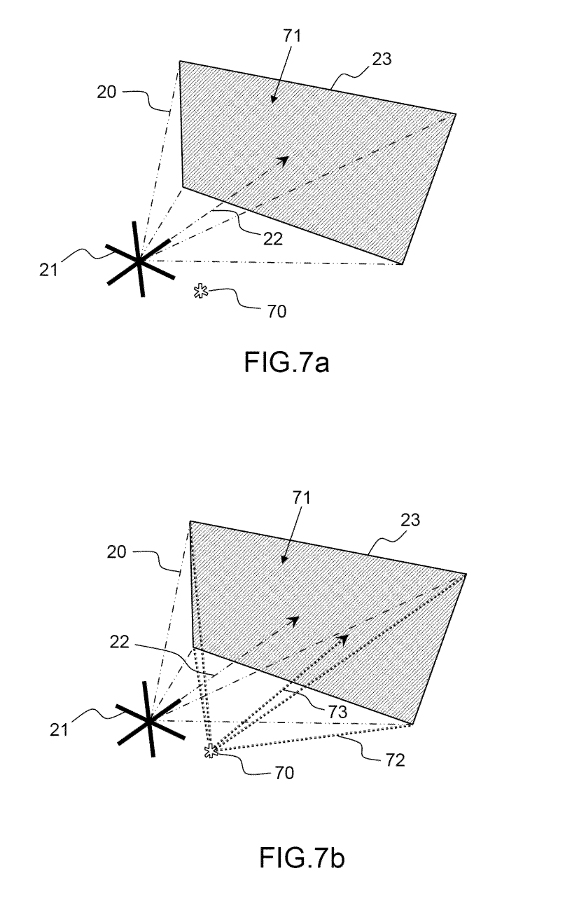

FIG. 7a: an initial vision pyramid;

FIG. 7b: a dynamic vision pyramid;

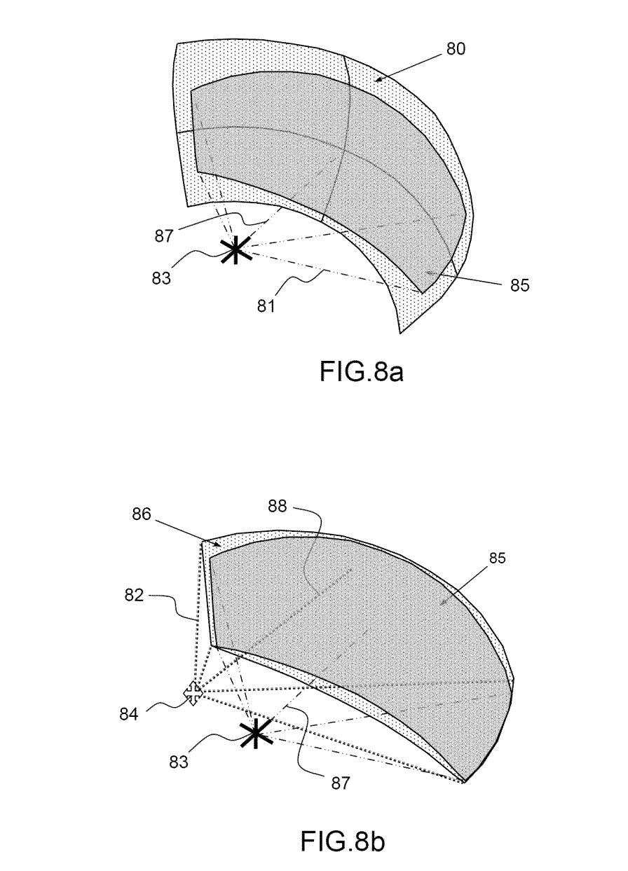

FIG. 8a: an initial vision pyramid for a spherical screen;

FIG. 8b: a dynamic vision pyramid for a spherical screen.

FIG. 1 represents a device 1 that can be used to display a visual scene on a screen, also called first display channel 1. The first display channel 1 is typically used in a simulator to restore a virtual environment intended for a user, or observer 5. Each first display channel 1 comprises a first synthesis image generator 2 and a first display means 3. The first synthesis generator 2 comprises a first database in three dimensions 4 comprising the characteristics of the scene to be viewed. The synthesis image generator also comprises a graphics processor 6 suitable for converting a scene in three dimensions into a virtual image in two dimensions. The graphics processor 6 may be replaced by equivalent software performing the conversion of a scene in three dimensions into a virtual image in two dimensions.

FIG. 2 represents an example of a conversion of a scene in three dimensions into a virtual image. Different conversion methods can be used in order to switch from a scene in three dimensions to a virtual image in two dimensions. One method that is well suited to artificially recreating a real visual environment is called “conical perspective”. The representation in conical perspective mode, also called “central projection”, is the transformation usually used in virtual reality, in augmented reality, in simulation and in video games. The central projection can be geometrically defined in space by a first so-called vision pyramid 20, positioned and oriented in the virtual world created in the first database in three dimensions 4. The observer 5 is positioned 21 at the top of the first vision pyramid 20. The observer 5 looks toward a first line of sight 22. The image seen by the observer 5 corresponding to a planar surface 23 substantially perpendicular to the first line, or axis, of sight 22. The planar surface 23 is notably delimited by the edges of the first vision pyramid 20.

FIG. 3 represents a second calibrated display channel 30 according to the prior art. In practice, in the fields of virtual reality, of augmented reality and simulation, a good visual immersion of an observer 5 notably uses a transformation of a scene in three dimensions into a virtual image in two dimensions, produced with a conical perspective or central projection, regardless of the display device. When the display of the elements in three dimensions of the first database in three dimensions 4, enables the observer 5 to correctly estimate the relative distances of the elements in three dimensions, then the display device is said to be calibrated 31. In order to calibrate the display device 31 for screens of various natures, such as flat, cylindrical, spherical, torroidal screens, a calibration device 32 is inserted into the second display channel 30, between the image generator 2 and a second display device 33. The calibration device 32 performs the calibration of the second display device for example on starting up the simulator. As it happens, once the calibration is established, there is no need to recalculate it each time a virtual image is displayed.

FIG. 4 represents an example of parallax error 40. A parallax error may occur when a display channel calibrated without detecting the position of the eyes of the observer 5 or without the use of a display device worn on the head of the observer 5 such as a helmet-mounted display. The observer 5 can see the scene with a central projection only when he or she is situated in a first position 42 of the space in front of a first screen 41. The first position 42 depends on parameters of a first initial vision pyramid used, such as the first vision pyramid 20 represented in FIG. 2, to calibrate the display, and on the size and the position of the first screen 41. The first position 42 can be called initial position 42 and is located at the top of the first initial vision pyramid 20. Thus, when the screens are at a distance close to the observer 5, significant geometrical aberrations appear when the eyes of the observer move away from the initial position 42. In FIG. 4, the observer is, for example, in a second position 43. The parallax error 40 can then be defined as an angle 40 between a first line of sight 44 starting from the initial position 42 and intersecting the first screen 41 at a first point 45 and a straight line 47 parallel to a second line of sight 46 starting from the second position 43 of the observer 5, said parallel straight line 47 passing through the initial position 42.

FIG. 5 represents a device for representing virtual environments 50 according to the invention. The virtual environment representation device is a second display channel 50 according to the invention. The environment representation device 50 comprises a second synthesis image generator 51 comprising a second database in three dimensions 52. The second database in three dimensions 52 comprises the same information as the first database in three dimensions 4. The third database in three dimensions 52 also comprises a description of the first initial vision pyramid 20. The second synthesis image generator 51 also comprises a second graphics processor 53 taking as input a dynamic vision pyramid for transforming the scene in three dimensions into a virtual image in two dimensions. A dynamic vision pyramid is created by a module for calculating a dynamic conformal transformation 56. The dynamic conformal transformation calculation 56 uses as input data:
the description of the initial vision pyramid 20, transmitted for example by the second synthesis image generator 51;
a geometrical description of the second calibrated virtual image display device 33, represented in FIG. 3;
a positioning of the eyes, of the head of the observer 5 in real time.

The dynamic conformal transformation calculation for example takes into account the position, the orientation, the shape of the screen relative to the observer 5. One aim of the dynamic conformal transformation calculation is notably to correct the synthesis images displayed to eliminate from them the geometric aberrations that can potentially be seen by the observer 5. Advantageously, the dynamic conformal transformation calculation produces an exact central projection of the virtual image perceived by the observer 5 regardless of the position of the observer in front of the screen.

The calculation of a dynamic conformal transformation is therefore performed in real time and takes into account the movements of the eyes or of the head of the observer in order to calculate in real time a new so-called dynamic vision pyramid. The position of the eyes or of the head can be given by a device for calculating the position of the eyes or of the head in real time 57, also called eye tracker, or head tracker. The device for calculating the position of the eyes or of the head of the observer takes account of the data originating from position sensors.

The virtual image in two dimensions created by the second graphics processor 53 can be transmitted to a dynamic distortion operator 54. Advantageously, a dynamic distortion operator 54 makes it possible to display a virtual image without geometric aberrations on one or more curved screens or on a display device comprising a number of contiguous screens, each screen constituting a display device that is independent of the other screens. In the case of a multichannel display, the environment representation device is duplicated as many times as there are display channels. Together, the display channels may form a single image in the form of a mosaic, or a number of images positioned anywhere in the space around the observer 5.

Then, the virtual image is transmitted to a third display device 55, previously calibrated by a calibration device 32 represented in FIG. 3. The virtual image displayed by the display device 55 is then perceived by an observer 5.

FIG. 6 represents different possible steps for the environment representation method 60 according to the invention. The environment representation method 60 according to the invention notably comprises a dynamic conformal transformation calculation 600, followed by a dynamic conformal transformation rendering calculation 601.

A first step prior to the method according to the invention may be a step 62 for the construction of an initial vision pyramid 20 by the synthesis image generator 51, represented in FIG. 5. A second step prior to the method according to the invention may be a step for calibration of the display device 55 represented in FIG. 5. The calibration step uses the initial vision pyramid 20, calculated during the first preliminary step 62. In another embodiment, the calibration process may be an iterative process during which the initial vision pyramid can be recalculated. A third step prior to the method 60 according to the invention is a step for describing shapes, positions and other physical characteristics 61 of the display device 55, represented in FIG. 5. The data describing the display device 55 may be, for example, backed up in a database, to be made available for the various calculations performed during the method 60 according to the invention.

A first step of the method according to the invention may be a step for detecting each new position of the eye of the observer and/or each new position and possibly orientation of the head of the observer 5. The position of the eyes, and/or the position and possibly the orientation of the head are transmitted to the dynamic conformal transformation calculation module 56, as represented in FIG. 5.

A second step of the method according to the invention may be a step for calculating a position of an observation point 67 determined according to each position and orientation of the head of the observer 63. The step for calculating a position of an observation point 67 may form part of the dynamic conformal transformation calculation 600. The position of the observation point can be deduced from data produced by an eye position detector. A position of the observation point is calculated as being a median position between the two eyes of the observer. It is also possible according to the context to take as position of the observation point a position of the right eye, a position of the left eye, or even any point of the head of the observer or even a point close to the head of the observer if a simple head position detector is used. In the case where a head position detector is used, the geometrical display errors of the method 60 according to the invention are greater, but remain advantageously acceptable according to the final use which can be made thereof. For the rest of the method according to the invention, a position of the observer can be defined as a deviation between the position of the observation point and the initial position 42 used for the calibration of the third display device 55.

A third step of the method according to the invention may be a step for calculating a dynamic vision pyramid 64. A new dynamic vision pyramid 64 is calculated in real time for each position of the head or of the eyes of the observer 5. The calculation of a dynamic vision pyramid 64 is notably performed according to a configuration 61 of the image restoration system, that is to say, the display device 55. The calculation of the dynamic vision pyramid is based on a modification of the initial vision pyramid 20 in order for the real visual field observed to completely encompass an initial display surface, by taking account of the position of the observation point 65 transmitted by the dynamic conformal transformation calculation 56. An initial display surface is a surface belonging to the surface of a second screen 55, or third display device 55, the outer contours of which are delimited by the intersection of the edges of the initial vision pyramid 20 with the second screen 55. The step for calculating a dynamic vision pyramid 64 may form part of the dynamic conformal transformation calculation 600.

A fourth step of the method according to the invention may be a step for calculating a rendering in two dimensions 65 for a scene in three dimensions 66, said 3D scene being, for example, generated by simulation software. 2D rendering calculation is performed by a dynamic conformal transformation rendering calculation function, also called second synthesis image generator 51. The calculation of the 3D rendering of the scene 69 may notably use a central projection in order to produce a new 2D image. The calculation of a rendering in two dimensions 65 may form part of the dynamic conformal transformation rendering calculation 601. In one embodiment of the invention, the next step may be a step for calculating a rendering of the 3D scene 69 suitable for display 602 by the representation device 55.

In a particularly advantageous embodiment, the method according to the invention may include a fifth step for calculation of the dynamic distortion 603, by a dynamic distortion operator 54 as represented in FIG. 5. During the fifth step 603, for each new position and orientation of the head or for each new position of the eyes of the observer, the distortions to be applied to conform to the conical perspective can be calculated. The calculation of the dynamic distortion 603 may form part of the dynamic conformal transformation calculation 600.

A sixth step of the method according to the invention may be a rendering calculation step following the application of the dynamic distortion 68 calculated during the fifth step 603 of the method according to the invention. The distortion produces a displacement of source pixels, that is to say pixels of the image calculated by the 3D image generator or else the 3D scene 66, to a new position to create a destination image suitable for display on the second screen 55 for example. The position of each source pixel can be defined by its coordinates (X_{S}, Y_{S}). A new position of the source pixel in the destination image may be defined by new coordinates (X_{D}, Y_{D}). The calculation for transforming source coordinates into destination coordinates is performed in such a way as to always preserve the central projection, regardless of the position of the observer and do so for each pixel displayed. The calculation of the parameters of each pixel (X_{S}, Y_{S}), (X_{D}, Y_{D}) can be carried out as follows: for each pixel of the initial pyramid 20 of coordinates (X_{S}, Y_{S}), find its position in the 3D space (x, y, z) on the screen, then calculate the position of this point of the space, as 3D coordinates (x, y, z) in the new dynamic vision pyramid 64, which gives new screen coordinates (X_{D}, Y_{D}).

The 2D image calculated during the fourth step 65 is therefore deformed, during the sixth step in real time so as to render a residual geometrical deviation of each observable pixel of the 2D rendering relative to an exact conical perspective of the 3D scene imperceptible to the observer. The dynamic distortion rendering calculation produces a rendering of the 3D scene 69 suitable for display 602 by the representation device 55.

Advantageously, the different calculations of the method according to the invention can be performed in real time and are visually imperceptible to the observer 5.

FIGS. 7a and 7b respectively illustrate examples of basic calculations of the initial 20 and dynamic 72 vision pyramids. FIG. 7a represents the first initial vision pyramid as also shown in FIG. 2. FIG. 7a also represents a real position of the observer 70 at a given time. FIG. 7b represents the first dynamic vision pyramid 72 calculated during the third step 64 of the process 60 according to the invention. FIG. 7b also represents the first initial vision pyramid 20 as represented in FIG. 7a.

Generally, a vision pyramid 20, 72 is a pyramid oriented according to a line of sight 22, 73. A vision pyramid may also be defined by a horizontal angular aperture and a vertical angular aperture. The origin or the apex of a vision pyramid 20, 72 is situated at a position corresponding to the observation position, or more generally the position of the observer.

Each vision pyramid 20, 72 has for its origin a position of the observer 21, 70 and for orientation, the direction of the line of sight 22, 73. The first surface or initial display area 23 is a surface belonging to the surface of the screen 71, the outlines of which are delimited by the intersection of the edges of the initial pyramid 20 with the screen 71.

At each new position 70 of the observer, the method according to the invention recalculates in real time a new dynamic vision pyramid 72.

In FIGS. 7a and 7b, a first type of display area is represented. The screen 71 used is typically in this case based on flat screens, forming a first planar and rectangular display area.

In FIG. 7b, the new dynamic vision pyramid is calculated according to a second line of sight 73, substantially perpendicular to the first initial display area 23. Each line of sight 73 used to calculate a new dynamic vision pyramid remains substantially perpendicular to the first initial display area 23. The calculation of a new dynamic vision pyramid is performed by determining four angles between the corners of the first initial display area 23, a current position of the observer 70 and a line of sight 22, 73 projected on to axes substantially parallel to the edges of the first display surface 23. Advantageously, such a dynamic vision pyramid construction in the case of a flat screen 71 gives an exact central projection and does not consequently require any distortion correction, but this is conditional on the use of a line of sight that is always substantially parallel to the first initial line of sight 22.

However, when the line of sight cannot be parallel to the first initial line of sight 22, still in the case of a flat screen 23, a dynamic distortion operator 54, as represented in FIG. 5, advantageously makes it possible to retain a calibrated display. The distortion operation performed by the dynamic distortion operator 54 during the fifth step 603 of the method according to the invention is applied to deform a polygon with four vertices.

FIGS. 8a and 8b represent examples of calculations of initial and dynamic vision pyramids when the screen takes any shape. For example, a third screen 80 represented in FIGS. 8a and 8b is a spherical screen.

As in FIGS. 7a, 7b, each vision pyramid 81, 82, has for its origin a position of the observer 83, 84 and, for orientation, the direction of the line of sight 87, 88. A second surface or initial display area 85 is a surface belonging to the surface of the third screen 80, the outlines of which are delimited by the intersection of the edges of a second initial pyramid 81 with the third screen 80. Similarly, at each new position 83 of the observer, the method according to the invention recalculates in real time a second new dynamic vision pyramid 82. The second new dynamic vision pyramid 82 is calculated in such a way that the aperture of the second new dynamic vision pyramid 82 has the smallest aperture encompassing the second initial display surface 85. Thus, a new display surface 86 totally encompasses the second initial display surface 85.

Advantageously, when the second new dynamic vision pyramid 82 has a greater aperture than the second initial display surface 85, the distortion operator 54 compensates by enlarging the 2D rendering image so as to preserve the exact conical perspective.

Advantageously, the invention can be used to train the drivers of cranes for example, or of other fixed work site craft. Driving such craft requires training in which the fidelity of the visual display is very important.

The invention can also be applied in the context of training personnel on foot in the context of hazardous missions, which requires a highly immersive display with small bulk.

The method according to the invention advantageously eliminates the parallax errors and does so regardless of the position of the observer in front of the screen. The method according to the invention advantageously makes it possible to obtain this result by maintaining a conical perspective or a central projection of the 3D scene seen by the observer.

Furthermore, the parallax errors are eliminated regardless of the position(s) of the display screen(s), regardless of the number of screens, regardless of the shape of the display screen(s).

1. A method for representing synthetic environments, suitable for viewing by at least one observer, said observer being able to be mobile, from a virtual scene in three dimensions, comprising the following steps:
a step for calibrating a display device for the synthetic representation of the virtual scene;
a step for constructing an initial vision pyramid;
a step for describing the physical characteristics (61) of the display device;
a first step for determining an observation position on each movement of the observer;
a second step for calculating a new dynamic vision pyramid according to the observation position, said new dynamic vision pyramid resulting from a dynamic conformal transformation calculation;
a third step for calculating a rendering in two dimensions of the virtual scene in three dimensions by a function of conformal dynamic transformation rendering calculation taking into account the new dynamic vision pyramid;
a fourth step for displaying, by a calibrated display device, the rendering in two dimensions of the virtual scene.

2. The method as claimed in claim 1, further comprising a step for calculating a dynamic distortion according to the observation position, followed by a step for applying the dynamic distortion to the rendering in two dimensions of the virtual scene, calculating a new rendering conforming to the conical perspective.

3. The method as claimed in claim 1, wherein the first step for determining an observation position comprises a step for detecting a new position of the observer, a step for calculating a new observation position.

4. The method as claimed in claim 3, wherein the observation position is deduced from a detection of a new position of the head of the observer.

5. The method as claimed in claim 3, wherein the observation position is deduced from a detection of a new position of the eyes of the observer.

6. The method as claimed in claim 1, wherein the initial vision pyramid:
is oriented according to an initial line of sight, said initial line of sight being substantially perpendicular to a screen of the display device;
has for its origin an initial observation position;
defines an initial display area by its intersection with the screen.

7. The method as claimed in claim 6, wherein the dynamic vision pyramid is calculated by determining its four angles between the corners of an initial display area, the position of the observer and a line of sight projected on to axes substantially parallel to the edges of the initial display surface.

8. The method as claimed in claim 6, wherein the dynamic vision pyramid is calculated by minimizing its aperture so as to encompass the initial display surface.

9. A device for representing synthetic environments, suitable for being viewed by at least one observer, said observer being able to be mobile, from a virtual scene in three dimensions, said device comprising at least:
a detector of positions of the observer;
a synthesis image generator, comprising:
at least one database storing an initial vision pyramid, the virtual scene in three dimensions;
at least one graphics processor calculating a first rendering in two dimensions of the scene in three dimensions from a dynamic vision pyramid;
a module for calculating a conformal dynamic transformation taking as input the initial vision pyramid, a physical description of the display device and supplying the graphics processor with the dynamic vision pyramid, calculated according to an observation position deduced from a position of the observer;
a calibrated display device displaying the first rendering in two dimensions of the scene in three dimensions.

10. The device as claimed in claim 9, further comprising a dynamic distortion operator taking as input the rendering in two dimensions of the scene in three dimensions and applying a dynamic distortion according to physical characteristics of the display device and the observation position so as to produce a second rendering in two dimensions conforming to the conical perspective, said rendering in two dimensions being displayed by the calibrated display device.
